(19) United States
(12) Patent Application Publication
(10) Pub. No.: US 2010/0270753 A1
(43) Pub. Date: Oct. 28, 2010

(54) HIGH STRENGTH COMPOSITE PIPE GASKET

(75) Inventor: Mark Knapp, Ravenna, OH (US)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: SpringSeal, Inc., Streetsboro, OH (US)

(21) Appl. No.: 12/767,203

(22) Filed: Apr. 26, 2010

Related U.S. Application Data
(60) Provisional application No. 61/172,912, filed on Apr. 27, 2009.

(51) Int. Cl. F16J 15/06

(52) U.S. Cl. 277/608

(57) ABSTRACT

A composite high strength annular gasket and method of forming same is used for forming a seal between two pipe members. The gasket comprises a sealing material having a first durometer, the sealing material provides a pliable flexing surface for forming a sealing connection between a mating pipe member and adjoining pipe member during assembly. The gasket also comprises a base material forming one or more cords having a second durometer, the one or more cords embedded in and bonded with the sealing material, providing enhanced anti-compression and tensile strength to the composite annular gasket. The base material has a durometer higher than the sealing material.

### CROSS REFERENCES TO RELATED APPLICATIONS

The following application claims priority to co-pending U.S. Provisional Patent Application Ser. No. 61/172,912 filed Apr. 27, 2009 entitled HIGH STRENGTH COMPOSITE PIPE GASKET. The above-identified application is incorporated herein by reference in its entirety for all purposes.

### TECHNICAL FIELD

The present disclosure relates to a high strength composite gasket and method of making same, and more specifically, a high strength composite gasket used to form a fluid-tight assembly connection between pipe members comprising a mating pipe and an adjoining pipe that is either inserted into or over the mating pipe and in sealing contact with the high strength composite gasket.

### BACKGROUND

For the transport of fluids that includes both liquids and gases, it is desirable to form a fluid-tight sealed connection when jointing two or more pipe sections together. Numerous applications exists for transporting drain or storm, potable, or waste water using pipe sections fabricated from polyvinyl chloride, thermoplastics, polyethylene, polypropylene, high density polyethylene (HDPE), concrete, and the like.

Gaskets are frequently used between the two pipe sections to be joined together, assisting in the formation of a fluid tight sealing connection therebetween. Some significant improvements in the industry include adding lubrication to the gaskets to facilitate the connection process between the sections of piping. For example, currently pending U.S. patent application Ser. No. 12/274,614 filed Nov. 11, 2008 entitled PERMANENTLY LUBRICATED FILM GASKET AND METHOD OF MANUFACTURE and its parent application, now U.S. Pat. No. 7,469,905 teach extruding a permanently lubricated film into a gasket. Pending patent application Ser. No. 12/274,614 and U.S. Pat. No. 7,469,905 (“the '905 patent”) are incorporated herein by reference in their entireties for all purposes.

In yet another example, U.S. patent application Ser. No. 11/666,763 filed May 2, 2007 entitled MOLDED GASKET AND METHOD OF MAKING teaches molding a low coefficient of friction film into a gasket. The Ser. No. 11/666,763 patent application is incorporated herein by reference in its entirety for all purposes.

It is not uncommon, especially for municipalities to require gaskets and seals that form a fluid-tight sealed connection between the pipe members meet various specifications, relating to sealing and strength before being approved for use. American Society for Testing and Materials (“ASTM International”) is one international standards organization that develops and publishes voluntary consensus technical standards for a wide range of materials, products and systems, and specifications relating to construction projects. The ASTM organization also establishes standards relating to pipe gaskets or seals used in the construction industry.

### SUMMARY

One example embodiment of the present disclosure includes a composite high strength annular gasket for forming a seal between two pipe members. The gasket comprises a sealing material having a first durometer. The sealing material provides a pliable flexing surface for forming a sealing connection between a mating pipe member and adjoining pipe member during assembly. The gasket further comprises a base material forming one or more cords having a second durometer. The one or more cords are embedded in and bonded with the sealing material, providing enhanced anti-compression and tensile strength to the composite annular gasket. The base material has a durometer higher in value than the durometer of the sealing material.

Another example embodiment of the present disclosure includes a method of forming a composite high strength annular gasket comprising loading first and second durometer materials into an extruder to form a composite extrudate. The first durometer material forms a sealing member of the composite extrudate that also provides support to the second durometer material. The second durometer material forms one or more cords during the co-extrusion process. The one or more cords provide anti-compression and tensile strength to the composite high strength annular gasket during assembly of connecting pipe members. The method also comprises co-extruding the first durometer material with the second durometer material through a die head of an extruder to form a composite extrudate, the first durometer material has a lower durometer value than the second durometer material. The method further comprises welding first and second ends of the composite extrudate to form a continuous composite high strength annular gasket.

A further example embodiment of the present disclosure includes a composite high strength annular gasket for forming a seal between two pipe members. The gasket comprises a sealing member formed from sealing material having a first durometer. The sealing material provides a pliable flexing surface for forming a sealing connection between a mating pipe member and adjoining pipe member during assembly. The gasket also comprises an base material formed from a second durometer, the base material provides enhanced anti-compression and tensile strength to the composite high strength annular gasket. The base material has a durometer higher than the sealing material. The gasket further comprises a plurality of cords formed from the base material, the plurality of cords are embedded in and supported by the sealing material. The gasket also comprises an anchor member integrally formed with sealing member, the anchor member is formed from the base material.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a cross sectional view of an annular composite high strength gasket constructed in accordance with one example embodiment of the present disclosure;

FIG. 2 is a cross sectional perspective view of an annular composite high strength gasket constructed in accordance with one example embodiment of the present disclosure;

FIG. 3 is a cross sectional view of the annular composite high strength gasket of FIG. 2;

FIG. 4 is a cross sectional view of an annular composite high strength gasket constructed in accordance with one example embodiment of the present disclosure;

FIG. 5 is a cross sectional view of an annular composite high strength gasket constructed in accordance with one example embodiment of the present disclosure;

FIG. 6 is a cross sectional partial view of an annular composite high strength gasket constructed in accordance with one embodiment of the present disclosure seated in one of two pipe members prior to forming a fluid-tight connection therebetween;

FIG. 7 is a cross sectional partial view of an annular composite high strength gasket constructed in accordance with one embodiment of the present disclosure seated in one of two pipe members, forming a fluid-tight connection therebetween;

FIG. 8 is a cross sectional partial view of an annular composite high strength gasket constructed in accordance with one embodiment of the present disclosure seated in one of two pipe members prior to forming a fluid-tight connection therebetween;

FIG. 9 is a cross sectional partial view of an annular composite high strength gasket constructed in accordance with one embodiment of the present disclosure seated in one of two pipe members, forming a fluid-tight connection therebetween;

FIG. 10 is a cross sectional view of an annular composite high strength gasket constructed in accordance with one example embodiment of the present disclosure;

FIG. 11 is a cross sectional view of an annular composite high strength gasket constructed in accordance with one example embodiment of the present disclosure;

FIG. 12 is a cross sectional view of an annular composite high strength gasket constructed in accordance with one example embodiment of the present disclosure;

FIG. 13A is a cross sectional view of an annular composite high strength gasket constructed in accordance with one example embodiment of the present disclosure;

FIG. 13B is a cross sectional view of an annular composite high strength gasket constructed in accordance with one example embodiment of the present disclosure;

FIG. 14 is a cross sectional view of an annular composite high strength gasket constructed in accordance with one example embodiment of the present disclosure;

FIG. 15 is a cross sectional partial view of an annular composite high strength gasket constructed in accordance with one embodiment of the present disclosure cast in one of two pipe members prior to forming a fluid-tight connection therebetween;

FIG. 16 is a cross sectional partial view of an annular composite high strength gasket constructed in accordance with one embodiment of the present disclosure cast in one of two pipe members, forming a fluid-tight connection therebetween;

FIG. 17 is a cross sectional partial view of an annular composite high strength gasket constructed in accordance with one embodiment of the present disclosure cast in one of two pipe members prior to forming a fluid-tight connection therebetween;

FIG. 18 is a cross sectional partial view of an annular composite high strength gasket constructed in accordance with one embodiment of the present disclosure cast in one of two pipe members, forming a fluid-tight connection therebetween;

FIG. 19 is a flowchart of exemplary embodiment of the present disclosure illustrating a method of forming an annular composite high strength gasket in accordance with one embodiment of the present disclosure; and

FIG. 20 is a cross sectional view of an annular composite high strength gasket constructed in accordance with one example embodiment of the present disclosure that was used in physical testing.

### DETAILED DESCRIPTION

Referring now to the figures in detail wherein like numbered features shown therein refer to like elements throughout unless otherwise noted. The present disclosure relates generally to a composite high strength gasket and method of making same, and more specifically, a composite high strength gasket used to form a fluid-tight assembly connection between pipe members comprising a mating pipe and an adjoining pipe that is either inserted into or over the mating pipe and in sealing contact with the composite high strength gasket.

The high strength gaskets of the present disclosure are advantageously designed to withstand the most rigorous piping interconnection applications, including for example, forming fluid-tight seals within concrete, steel, and/or cast iron pipes (hereinafter “high strength sealing applications” or “heavy duty applications”). Such heavy duty applications impose forces and pressures on the gasket several times that of plastic or corrugation type applications. The high strength gaskets of the present disclosure, as further discussed below are annular gaskets suitable for heavy duty applications requiring the gaskets' diameter to be from just a few inches to several feet.

Gaskets intended for use in plastic corrugated pipe or plastic tubing made with belts or fibers may be suitable for plastic piping stresses, but lack the strength necessary for a high strength composite gasket used for concrete, cast iron, or steel piping. For example, U.S. Pat. No. 5,326,138 entitled HIGH PRESSURE COUPLING FOR PLASTIC PIPE AND CONDUIT (hereinafter “the '138 patent”) describes a gasket for use with plastic tubing or plastic corrugated tubing having internal belts or fibers. The internal belts or fibers in the '138 patent lacks the necessary elastic properties of the present disclosure, since the belts or fibers are incapable of achieving the amount of elongation advantageously achieved by the present disclosure, which is beneficial in heavy duty applications such as in concrete, cast iron, and/or steel piping connections. In addition, the fibers or belts discussed in the '138 patent typically require primer or an adhesive to connect the hard rubber material to the belts or fibers, which is also subject to premature yielding in high strength sealing applications.

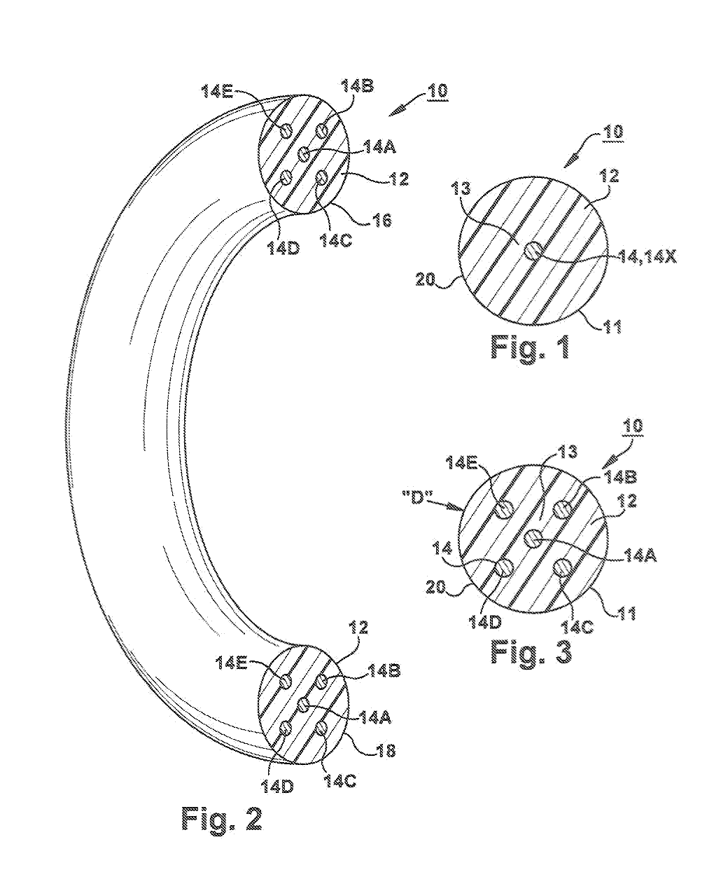

Referring again to the figures and in particular to FIG. 1 is a cross-sectional view of an annular composite high strength gasket 10 constructed in accordance with one exemplary embodiment of the present disclosure. In the illustrated example embodiment of FIG. 1, the composite high strength gasket 10 comprises sealing material 12 having a first durometer of relatively soft material and a base material 14 forming a cord 14X having a second durometer of a higher and relatively harder material than the sealing material.

In the illustrated example embodiment of FIG. 1, the base material 14 forming the cord 14X is circular in shape and circularly surrounded by the sealing material 12. The base material 14 forming the cord 14X, provides relatively significant elongation strength, axial strength (compressive and tensile), and shear strength (both positive and negative) properties, along with relatively high impact properties when compared to the sealing material 12.

The sealing material 12 provides relatively significant sealing properties when compared to the base material 14 forming cords 14X, such that the sealing material readily conforms to the geometry generated by the piping connection formed between pipe members. The base material 14 forming the cord 14X is also capable of deforming, although to a relatively lesser degree than the sealing material 12 to facilitate forming the fluid-tight seal connection between piping members.

When the sealing material 12 is joined by for example, co-extruding the sealing material with the base material 14 forming the cord 14X, the sealing material experiences a substantial enhancement in elongation strength, axial strength (compressive and tensile), and shear strength (both positive and negative) properties, along with a relatively high increase in impact properties when compared to the sealing material 12 by itself. While the sealing material 12, continues to provide enhanced sealing properties as a result of its lower durometer and positioning about the base material 14.

Illustrated in FIGS. 2 and 3 is a cross-sectional view of annular composite high strength gasket 10 constructed in accordance with another exemplary embodiment of the present disclosure. The composite high strength gasket 10 illustrated in FIGS. 2 and 3 includes sealing material 12 having a first durometer of relatively soft material and a base or cord material 14 comprising a plurality of cords 14A-14E, each having a second durometer of a relatively harder and higher durometer material than the sealing material.

The cord 14 or cords 14A-14E in the illustrated embodiments of FIGS. 1-3 are symmetrically located and in FIGS. 2-3 isolated from contact between each cord by die sealing material 12 that supports the cords 14A-14E from the outside diameter 11 to the central portion 13 of the composite gasket 10 throughout the entire annular configuration. In FIG. 1, the cord 14 is substantially concentrically located within the sealing material 12.

The cords 14A-14E in FIGS. 2-3 form generally an “X” shaped configuration having a substantially circular cross-section and are centrally and symmetrically located within the sealing material 12. The base material 14 forming cords 14A-14E provides relatively significant elongation strength, axial strength (compressive and tensile), and shear strength (both positive and negative) properties, along with relatively high impact properties when compared to the sealing material 12.

The sealing material 12 provides relatively significant sealing properties when compared to the base material 14 forming cords 14A-14E, such that the sealing material readily conforms to the geometry formed by the piping connection formed between pipe members. The base material 14 forming cords 14A-14E is also capable of deforming, although to a relatively lesser degree than the sealing material to facilitate forming the fluid-tight seal connection between piping members.

When the sealing material 12 is joined by for example, co-extruding the sealing material with the cord material 14A-14E, the sealing material 12 experiences a substantial enhancement in elongation strength, axial strength (compressive and tensile), and shear strength (both positive and negative) properties, along with a relatively high increase in impact properties when compared to the sealing material 12 by itself. While the sealing material 12, continues to provide enhanced sealing properties as a result of its lower durometer and positioning about the base material 14.

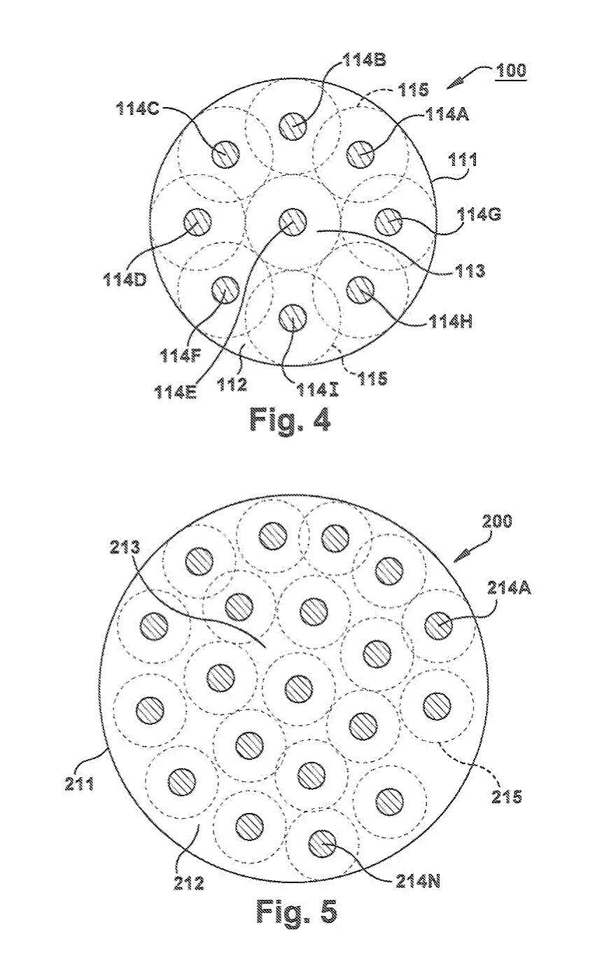

Illustrated in FIG. 4 is a cross-sectional view of annular composite high strength gasket 100 constructed in accordance with another exemplary embodiment of the present disclosure. The composite high strength gasket 100 illustrated in FIG. 4 includes sealing material 112 having a first durometer of relatively soft material and a base or cord material 114 comprising a plurality of cords 114A-114I, each having a second durometer of a relatively harder and higher durometer material than the sealing material.

The cords 114A-114I in the illustrated example embodiments of FIG. 4 include a circular cross-section and are symmetrically located and isolated from contact between each cord by the sealing material 112 that supports the cords 114A-114I from the outside 111 diameter to the central portion 113 of the composite gasket 100 throughout the entire annular configuration. As can be seen in FIG. 4, a substantially equal amount of surface area 115 (shown in phantom) of the sealing material 112 is divided equally and equally spaced about each of the cords 114A-114I.

The cords 114A-114I form generally a star chamber shaped configuration and are centrally and symmetrically located within the sealing material 112. The base material 114 forming cords 114A-114I provides relatively significant elongation strength, axial strength (compressive and tensile), and shear strength (both positive and negative) properties, along with relatively high impact properties when compared to the sealing material 112.

The sealing material 112 provides relatively significant sealing properties when compared to the base material 114 forming cords 114A-114I, such that the sealing material readily conforms to the geometry formed by the piping connection formed between pipe members. The base material 114 forming the cords 114A-114I is also capable of deforming, although to a relatively lesser degree than the sealing material to facilitate forming the fluid-tight seal connection between piping members.

When the sealing material 112 is joined by for example, co-extruding the sealing material with the base material 114 forming the cords 114A-114I, the sealing material 112 experiences a substantial enhancement in elongation strength, axial strength (compressive and tensile), and shear strength (both positive and negative) properties, along with a relatively high increase in impact properties when compared to the sealing material 112 by itself. While the sealing material 112, continues to provide enhanced sealing properties as a result of its lower durometer and positioning about the base material 114.

Illustrated in FIG. 5 is a cross-sectional view of annular composite high strength gasket 200 constructed in accordance with another exemplary embodiment of the present disclosure. The composite high strength gasket 200 illustrated in FIG. 5 includes sealing material 212 having a first durometer of relatively soft material and a base material 214 forming any number of cords 214A-2140N, each having a second durometer of a relatively harder and higher durometer material than the sealing material.

The cords 214A-214N in the illustrated example embodiments of FIG. 5 include a circular cross-section and are randomly located and isolated from contact between each cord by the sealing material 212 that supports the cords 214A-214N from the outside 211 diameter to the central portion 213 of the composite gasket 200 throughout the entire annular configuration. As can be seen in FIG. 5, substantially equal amounts of surface area 215 (shown in phantom) of the sealing material 212 is divided and spaced about each of the cords 214A-214N.

The cords 214A-214N form generally a random configuration within the sealing material 212. The base material 214 forming the cords 214A-214N provides relatively significant elongation strength, axial strength (compressive and tensile), and shear strength (both positive and negative) properties, along with relatively high impact properties when compared to the sealing material 212.

The sealing material 212 provides relatively significant sealing properties when compared to the base material 214 forming the cords 214A-214N, such that the sealing material readily conforms to the geometry formed by the piping connection formed between pipe members. The base material 214 forming the cords 214A-214N is also capable of deforming, although to a relatively lesser degree than the sealing material to facilitate forming the fluid-tight seal connection between piping members.

When the sealing material 212 is joined by for example, co-extruding the sealing material with the cord material 214A-214N, the sealing material 212 experiences a substantial enhancement in elongation strength, axial strength (compressive and tensile), and shear strength (both positive and negative) properties, along with a relatively high increase in impact properties when compared to the sealing material 212 by itself. While the sealing material 212, continues to provide enhanced sealing properties as a result of its lower durometer and positioning about the base material 214.

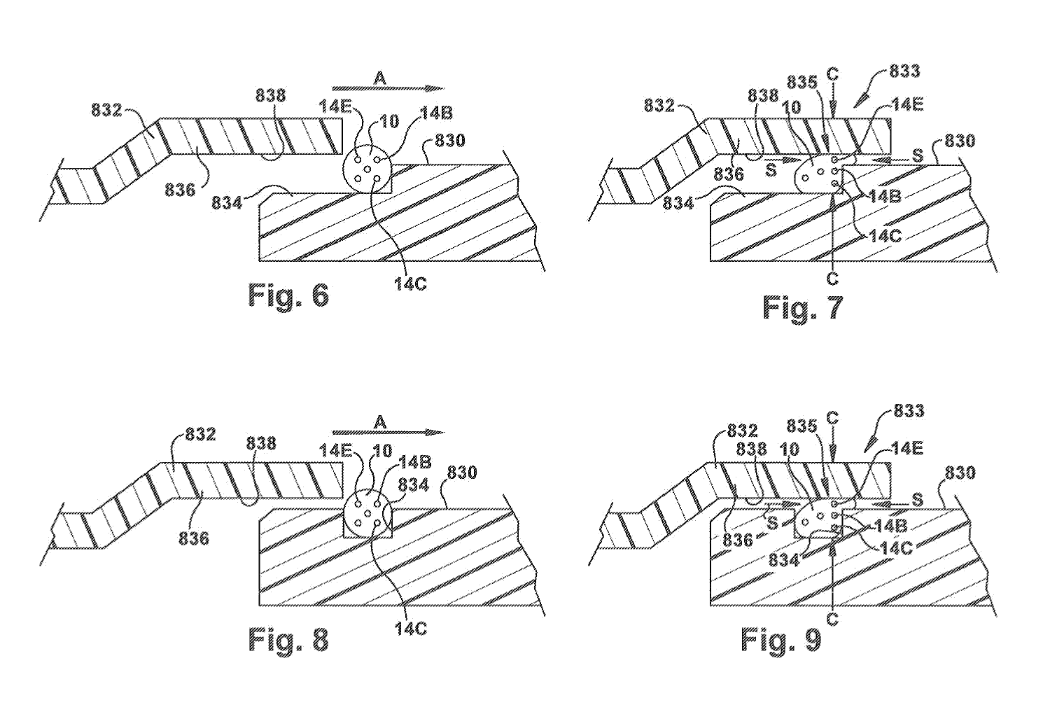

Illustrated in FIGS. 6-9 are cross sectional partial views of the annular composite high strength gasket 10 constructed in accordance with one example embodiment of the present disclosure seated in one of an adjoining pipe member 830 and mating pipe member 832 to form a sealing connection 833 (see FIGS. 7 and 9) therebetween. While FIGS. 6-9 illustrate the composite high strength gasket 10, it would be appreciated by one skilled in the art that any of the high strength gaskets discussed in the exemplary embodiments of this disclosure, for example, gaskets 10, 100, and 200 could be used to achieve the sealing connection 833 of FIGS. 6-9.

In the illustrated example embodiment of FIGS. 6-9, the adjoining member 830 also referred to as a spigot comprises a seat 834 in which the composite high strength gasket 10 is located prior to (FIGS. 6 and 8), and during assembly (FIGS. 7 and 9). The annular composite high strength gasket 10 is stretched around the diameter of the adjoining pipe member 830 (a partial sectional view shown) into the seat 834 prior to assembly. Once the annular composite high strength gasket 10 is seated, the mating pipe member 832 having a bell or hub portion 836 (a partial sectional view shown) is inserted or advanced in the direction of arrows A over the top of the composite high strength gasket, compressing the gasket with an inner portion 838 of the bell into the seat 834 to form a fluid-tight connection 833, as shown in FIGS. 7 and 9.

It should be appreciated by one skilled in the art that the seat 834 could equally be located in the mating pipe member 832. It would equally be appreciated by one skilled in the art that the seat 834 could be located within both the mating pipe member 832 and adjoining pipe member 830.

Another enhanced strength design feature is illustrated in the example embodiments of FIGS. 7 and 9 of the high strength gasket 10, 100, and 200 of the present disclosure. In particular, the gasket 10, 100, and 200 when shaped to form the fluid-tight sealing connection 833 of FIGS. 7 and 9, generates a substantially aligned pattern of two or more cords 14A-14N, forming a barrel stack 835 annularly along compression axis “C” and positioning at least one cord 14 annularly within the shear axis “S”. This annular configuration of the high strength gasket 10, 100, and 200 along the shear “S” and compression “C” axes significantly increase the strength of the seal 833. In the illustrated example embodiment, the barrel stack 835 is formed by cords 14E, 14B, and 14C.

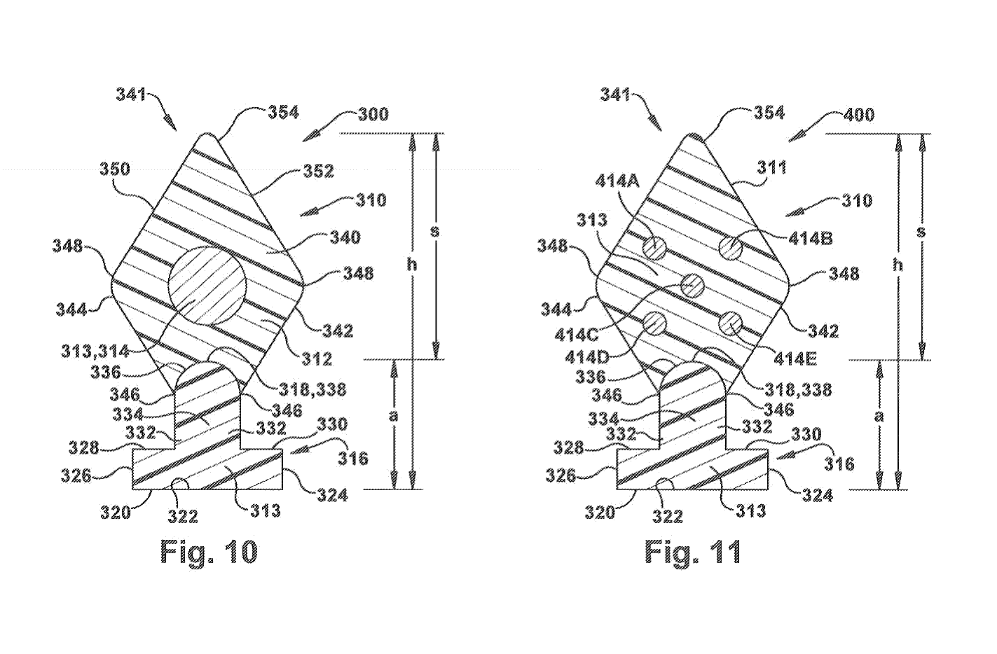

Illustrated in FIG. 10 is a cross-sectional view of annular composite high strength gasket 300 constructed in accordance with another exemplary embodiment of the present disclosure. The composite high strength gasket 300 illustrated in FIG. 10 includes a sealing member 310 comprising sealing material 312 having a first durometer of relatively soft material and a base material 314 comprising a single cord 313. The cord 313 and base material 314 have a second durometer of a relatively harder and higher durometer material than the sealing material 312.

Integrally formed by for example extruding, co-extruding, or molding with the sealing member 310 is an anchor member 316. The anchor member 316 is also formed from the base material 314. The anchor member 316 comprises a distal end 318 and a proximal end 320. The proximal end 320 comprises a seat 322 having first and second risers, 324 and 326, respectively transversely extending therefrom. The risers 324, 326 terminate at respective shelving portions 328, 330 that transversely extend therefrom to a connecting element 334 that joins the proximal end 320 of the anchor 316 to the distal end 318. The connecting element 334 centrally extends from risers 324, 326 and symmetrically from the proximal end 320 by sides 332 to an arcuate region 336 to an apex 338 of the distal end 318.

At least a portion of the distal end 318 is integrally formed into the sealing member 310, and in the illustrated example embodiment of FIG. 10, the arcuate region 336 is submerged within the sealing member. In the illustrated embodiment, the overall height “h” of the gasket 300 comprises an anchor height “a” that is substantially equal in proportion to a sealing height “s” to form the overall height. The overall height “h” can be from one inch (1″) to several inches.

The sealing member 310 comprises a generally diamond shaped head 341, having two diverging sides 342 and 344 that diverge from the anchor member 316 at a base 346 to horizontal peaks 348. From the horizontal peaks 348, the sealing member comprises two converging sides 350 and 352 that join at an arcuate tip 354 of the sealing member 310.

In the illustrated example embodiment of FIG. 10, the base material 314 of cord 313 is circular in shape and diamondangularly surrounded by the sealing material 312. The base material 314 forming the cord 313 provides relatively significant elongation strength, axial strength (compressive and tensile), and shear strength (both positive and negative) properties, along with relatively high impact properties when compared to the sealing material 312.

The sealing material 312 provides relatively significant sealing properties when compared to the base material 314 of the cord 313, such that the sealing material readily conforms to the geometry generated by the piping connection formed between pipe members. The base material 314 of cord 313 is also capable of deforming, although to a relatively lesser degree than the sealing material 312 to facilitate forming the fluid-tight seal connection between piping members.

When the sealing material 312 is joined by for example, co-extruding the sealing material with the base material 314 of the cord 313, the sealing material experiences a substantial enhancement in elongation strength, axial strength (compressive and tensile), and shear strength (both positive and negative) properties, along with a relatively high increase in impact properties when compared to the sealing material 312 by itself. While the sealing material 312, continues to provide enhanced sealing properties as a result of its lower durometer and positioning about the base material 314.

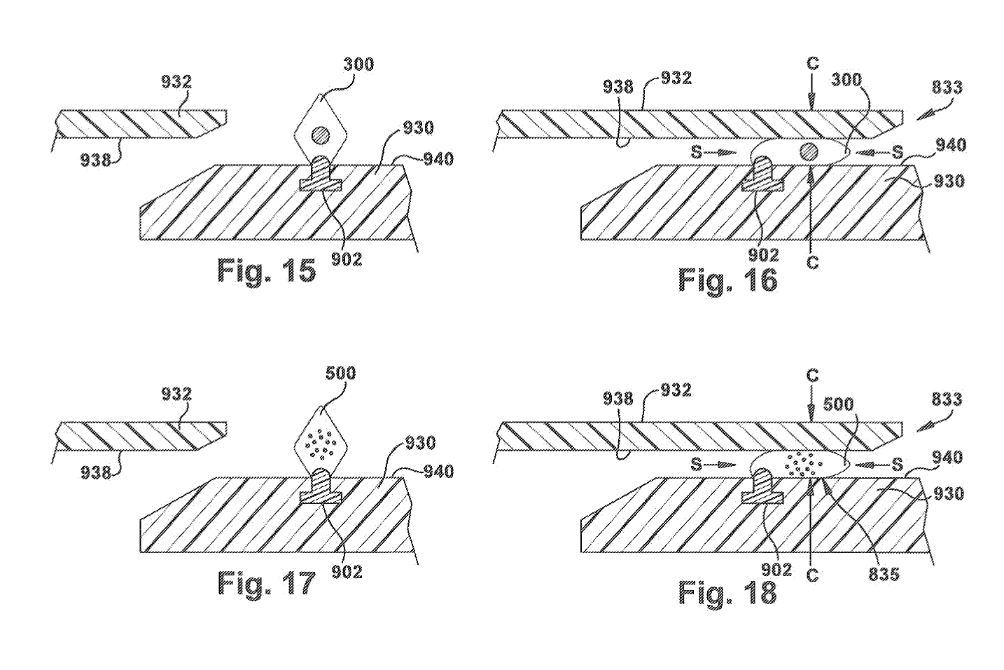

As will be further discussed below in detail, the anchor member 316 comprising the base material 314 is designed to be cast or locked into one of the two piping members that form the fluid-tight connection 833. The geometrical design of the anchor 316 and sealing member 310 and their interconnection are advantageously constructed to provide optimal sealing capabilities with enhanced strength characteristics. The anchor member 316 comprises substantially resilient shelving portions 328 and 330 that restrain the anchor member 316 within a wall 902 of a pipe member 930 (see FIGS. 15-18). The connecting element 334 is advantageously symmetrically located in the anchor member 316 extending to the sealing member 310 and is of sufficient width defined by sides 332 to prevent fracture or fatigue during assembly or compressive and tensile stresses experienced in use. The arcuate region 336 of the distal end 318 of the anchor member 316 maximizes the surface area along the radial axis of the annular gasket of the interconnection between the sealing member 310 and anchor such that the risk fatigue and/or facture is lessoned.

In addition to the advantages discussed relating to the base material 314 of cord 313 being positioned within the sealing member 310, the geometrical construction of the sealing member and anchor member 316 provide enhanced sealing properties. For example the reduced width at distal end 318 of the anchor 316, expanding by way of the diverging sides 340 and 342 of the sealing member 310 provide superior flexibility to the gasket as the pipe members are being assembled. In addition, the diverging sides 340 and 342 expansion to horizontal peaks 348 is the widest portion of the gasket, maximizing the amount of material used to form the seal in the fluid-tight connection 833. The converging sides 350 and 352 to the arcuate tip 354 reduces material cost by the reduced size while providing a sufficient slope to reassure a fluid-tight connection.

Illustrated in FIG. 11 is a cross-sectional view of annular composite high strength gasket 400 constructed in accordance with another exemplary embodiment of the present disclosure. The composite high strength gasket 400 illustrated in FIG. 11 includes a sealing member 310 comprising sealing material 312 having a first durometer of relatively soft material and a base material 314 formed into a plurality of cords 414A-414F, each having a second durometer of a relatively harder and higher durometer material than the sealing material.

Integrally formed by for example extruding, co-extruding, or molding with the sealing member 310 is an anchor member 316. The anchor member 316 is also formed from the base material 314. The anchor member 316 comprises a distal end 318 and a proximal end 320. The proximal end 320 comprises a seat 322 having first and second risers, 324 and 326, respectively transversely extending therefrom. The risers 324, 326 terminate at respective shelving portions 328, 330 that transversely extend therefrom to a connecting element 334 that joins the proximal end 320 of the anchor to the distal end 318. The connecting element 334 centrally extends from risers 324, 326 and symmetrically from the proximal end 320 by sides 332 to an arcuate region 336 to an apex 338 of the distal end 318.

At least a portion of the distal end 318 is integrally formed into the sealing member 310, and in the illustrated example embodiment of FIG. 11, the arcuate region 336 is submerged within the sealing member. In the illustrated embodiment, the overall height “h” of the gasket 400 comprises an anchor height “a” that is substantially equal in proportion to a sealing height “s” to form the overall height. The overall height “h” can be from one inch (1″) to several inches.

The sealing member 310 comprises a generally diamond shaped head 341, having two diverging sides 342 and 344 that diverge from the anchor member 316 at a base 346 to horizontal peaks 348. From the horizontal peaks 348, the sealing member comprises two converging sides 350 and 352 that join at an arcuate tip 354 of the sealing member 310.

The cords 414A-414E in the illustrated embodiment of FIG. 11 are symmetrically located and isolated from contact between each cord by the sealing material 312 that supports the cords 414 from the outside surface 311 to the central portion 313 of the composite gasket 400 throughout the entire annular configuration.

The cords 414A-414E in FIG. 11 form generally an “X” shaped configuration having a substantially circular cross-section and are centrally and symmetrically located within the sealing material 312. The base material of cords 414A-414E provides relatively significant elongation strength, axial strength (compressive and tensile), and shear strength (both positive and negative) properties, along with relatively high impact properties when compared to the sealing material 312.

The sealing material 312 provides relatively significant sealing properties when compared to the base material 314 of cords 414, such that the sealing material readily conforms to the geometry formed by the piping connection formed between pipe members. The base material 314 of cords 414 is also capable of deforming, although to a relatively lesser degree than the sealing material to facilitate forming the fluid-tight seal connection between piping members.

When the sealing material 312 is joined by for example, co-extruding the sealing material with the base material forming cords 414A-414E, the sealing material 312 experiences a substantial enhancement in elongation strength, axial strength (compressive and tensile), and shear strength (both positive and negative) properties, along with a relatively high increase in impact properties when compared to the sealing material 312 by itself. While the sealing material 312, continues to provide enhanced sealing properties as a result of its lower durometer and positioning about the base material 314.

As will be further discussed below in detail, the anchor member 316 comprising the base material 314 is designed to be cast or locked into one of the two piping members that form the fluid-tight connection 833. The geometrical design of the anchor 316 and sealing member 310 and their interconnection are advantageously constructed to provide optimal sealing capabilities with enhanced strength characteristics. The anchor member 316 comprises substantially resilient shelving portions 328 and 330 that restrain the anchor member 316 within a wall 902 of a pipe member 930 (see FIGS. 15-18). The connecting element 334 is advantageously symmetrically located in the anchor member 316 extending to the sealing member 310 and is of sufficient width defined by sides 332 to prevent fracture or fatigue during assembly or compressive and tensile stresses experienced in use. The arcuate region 336 of the distal end 318 of the anchor member 316 maximizes the surface area along the radial axis of the annular gasket of the interconnection between the sealing member 310 and anchor such that the risk fatigue and/or facture is lessoned.

In addition to the advantages discussed relating to the base material 314 of cords 414 positioned within the sealing member 310, the geometrical construction of the sealing member and anchor member 316 provide enhanced sealing properties. For example the reduced width at distal end 318 of the anchor 316, expanding by way of the diverging sides 340 and 342 of the sealing member 310 provide superior flexibility to the gasket as the pipe members are being assembled. In addition, the diverging sides 340 and 342 expansion to horizontal peaks 348 is the widest portion of the gasket, maximizing the amount of material used to form the seal in the fluid-tight connection 833. The converging sides 350 and 352 to the arcuate tip 354 reduces material cost by the reduced size while providing a sufficient slope to reassure a fluid-tight connection.

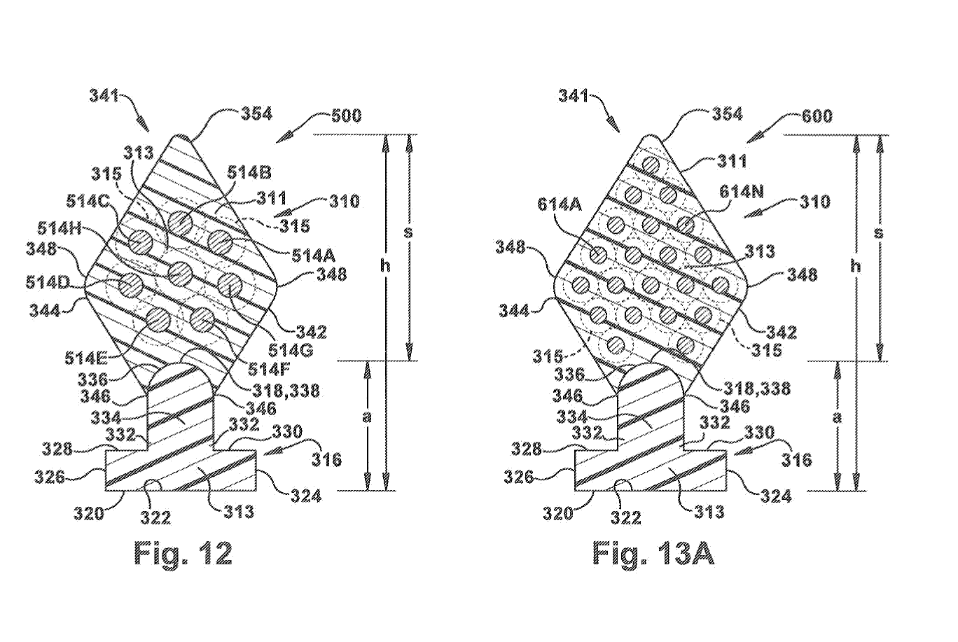

Illustrated in FIG. 12 is a cross-sectional view of annular composite high strength gasket 500 constructed in accordance with another exemplary embodiment of the present disclosure. The composite high strength gasket 500 illustrated in FIG. 12 includes a sealing member 310 comprising sealing material 312 having a first durometer of relatively soft material and a base material 314 formed into a plurality of cords 514A-514H, each having a second durometer of a relatively harder and higher durometer material than the sealing material.

Integrally formed by for example extruding, co-extruding, or molding into the sealing member 310 is an anchor member 316. The anchor member 316 is also formed from the base material 314. The anchor member 316 comprises a distal end 318 and a proximal end 320. The proximal end 320 comprises a seat 322 having first and second risers, 324 and 326, respectively transversely extending therefrom. The risers 324, 326 terminate at respective shelving portions 328, 330 that transversely extend therefrom to a connecting element 334 that joins the proximal end 320 of the anchor to the distal end 318. The connecting element 334 centrally extends from risers 324, 326 and symmetrically from the proximal end 320 by sides 332 to an arcuate region 336 to an apex 338 of the distal end 318.

At least a portion of the distal end 318 is integrally formed with the sealing member 310, and in the illustrated example embodiment of FIG. 12, the arcuate region 336 is submerged within the sealing member. In the illustrated embodiment, the overall height “h” of the gasket 500 comprises an anchor height “a” that is substantially equal in proportion to a sealing height “s” to form the overall height. The overall height “h” can be from one inch (1″) to several inches.

The sealing member 310 comprises a generally diamond shaped head 341, having two diverging sides 342 and 344 that diverge from the anchor member 316 at a base 346 to horizontal peaks 348. From the horizontal peaks 348, the sealing member comprises two converging sides 350 and 352 that join at an arcuate tip 354 of the sealing member 310.

The cords 514A-514H in the illustrated example embodiments of FIG. 12 include a circular cross-section and are symmetrically located and isolated from contact between each cord by the sealing material 312 that supports the cords 514 from the outside surface 311 to the central portion 313 of the composite gasket 100 throughout the entire annular configuration. As can be seen in FIG. 12, a substantially equal amount of surface area 315 (shown in phantom) of the sealing material 312 is divided substantially equally and equally spaced about each of the cords 514A-514H.

The cords 514A-514H form generally a star chamber shaped configuration and are centrally and symmetrically located within the sealing material 312. The base material 314 of cords 514A-514I provides relatively significant elongation strength, axial strength (compressive and tensile), and shear strength (both positive and negative) properties, along with relatively high impact properties when compared to the sealing material 312.

The sealing material 312 provides relatively significant sealing properties when compared to the base material 314 of the cords 514, such that the sealing material readily conforms to the geometry formed by the piping connection formed between pipe members. The base material 314 of the cords 514 is also capable of deforming, although to a relatively lesser degree than the sealing material to facilitate forming the fluid-tight seal connection between piping members.

When the sealing material 312 is joined by for example, co-extruding the sealing material with the base material 314 forming the cords 514A-514H, the sealing material 312 experiences a substantial enhancement in elongation strength, axial strength (compressive and tensile), and shear strength (both positive and negative) properties, along with a relatively high increase in impact properties when compared to the sealing material 312 by itself. While the sealing material 312, continues to provide enhanced sealing properties as a result of its lower durometer and positioning about the base material 314.

As will be further discussed below in detail, the anchor member 316 comprising the base material 314 is designed to be cast or locked into one of the two piping members that form the fluid-tight connection 833. The geometrical design of the anchor 316 and sealing member 310 and their interconnection are advantageously constructed to provide optimal sealing capabilities with enhanced strength characteristics. The anchor member 316 comprises substantially resilient shelving portions 328 and 330 that restrain the anchor member 316 within a wall 902 of a pipe member 930 (see FIGS. 15-18). The connecting element 334 is advantageously symmetrically located in the anchor member 316 extending to the sealing member 310 and is of sufficient width defined by sides 332 to prevent fracture or fatigue during assembly or compressive and tensile stresses experienced in use. The arcuate region 336 of the distal end 318 of the anchor member 316 maximizes the surface area along the radial axis of the annular gasket of the interconnection between the sealing member 310 and anchor such that the risk fatigue and/or facture is lessoned.

In addition to the advantages discussed relating to the base material 314 of cords 514 positioned within the sealing member 310, the geometrical construction of the sealing member and anchor member 316 provide enhanced sealing properties. For example the reduced width at distal end 318 of the anchor 316, expanding by way of the diverging sides 340 and 342 of the sealing member 310 provide superior flexibility to the gasket as the pipe members are being assembled. In addition, the diverging sides 340 and 342 expansion to horizontal peaks 348 is the widest portion of the gasket, maximizing the amount of material used to form the seal in the fluid-tight connection 833. The converging sides 350 and 352 to the arcuate tip 354 reduces material cost by the reduced size while providing a sufficient slope to reassure a fluid-tight connection.

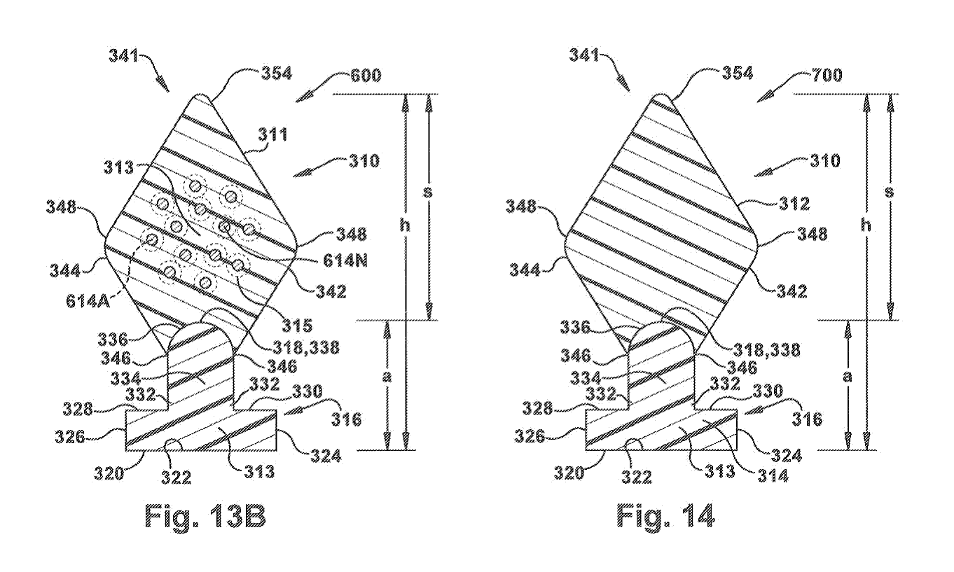

Illustrated in FIGS. 13A and 13B is a cross-sectional view of annular composite high strength gasket 600 constructed in accordance with another exemplary embodiment of the present disclosure. The composite high strength gasket 600 illustrated in FIGS. 13A and 13B includes a sealing member 310 comprising sealing material 312 having a first durometer of relatively soft material and a base material 314 forming any number of cords 614A-614N, each having a second durometer of a relatively harder and higher durometer material than the sealing material.

Integrally formed by for example extruding, co-extruding, or molding with the sealing member 310 is an anchor member 316. The anchor member 316 is also formed from the base material 314. The anchor member 316 comprises a distal end 318 and a proximal end 320. The proximal end 320 comprises a seat 322 having first and second risers, 324 and 326, respectively transversely extending therefrom. The risers 324, 326 terminate at respective shelving portions 328, 330 that transversely extend therefrom to a connecting element 334 that joins the proximal end 320 of the anchor to the distal end 318. The connecting element 334 centrally extends from risers 324, 326 and symmetrically from the proximal end 320 by sides 332 to an arcuate region 336 to an apex 338 of the distal end 318.

At least a portion of the distal end 318 is integrally formed into the sealing member 310, and in the illustrated example embodiment of FIGS. 13A and 13B, the arcuate region 336 is submerged within the sealing member. In the illustrated embodiment, the overall height “h” of the gasket 600 comprises an anchor height “a” that is substantially equal in proportion to a sealing height “s” to form the overall height. The overall height “h” can be from one inch (1″) to several inches.

The sealing member 310 comprises a generally diamond shaped head 341, having two diverging sides 342 and 344 that diverge from the anchor member 316 at a base 346 to horizontal peaks 348. From the horizontal peaks 348, the sealing member comprises two converging sides 350 and 352 that join at an arcuate tip 354 of the sealing member 310.

The cords 614A-614N in the illustrated example embodiments of FIG. 13A include a circular cross-section and are randomly located and isolated from contact between each cord by the sealing material 312 that supports the cords 614 from the outside surface 311 to the central portion 313 of the composite gasket 600 throughout the entire annular configuration. Such configuration equally applies to FIG. 13B, however, the pattern is not randomly shaped, but instead comprises (4) inner cords 614 surrounded by (8) outer cords within the sealing member 310. As can be seen in FIGS. 13A and 13B, substantially equal amounts of surface area 315 (shown in phantom) of the sealing material is divided and spaced about each of the cords 614A-614N.

The cords 614A-614N form generally a random configuration within the sealing material 312 in FIG. 13A. The base material 314 forming cords 614A-614N provides relatively significant elongation strength, axial strength (compressive and tensile), and shear strength (both positive and negative) properties, along with relatively high impact properties when compared to the sealing material 312.

The sealing material 312 provides relatively significant sealing properties when compared to the base material 314 forming cords 614, such that the sealing material readily conforms to the geometry formed by the piping connection formed between pipe members. The base material 314 of cords 614 is also capable of deforming, although to a relatively lesser degree than the sealing material to facilitate forming the fluid-tight seal connection between piping members.

When the sealing material 312 is joined by for example, co-extruding the sealing material with the cord material 614A-614N, the sealing material 312 experiences a substantial enhancement in elongation strength, axial strength (compressive and tensile), and shear strength (both positive and negative) properties, along with a relatively high increase in impact properties when compared to the sealing material 312 by itself. While the sealing material 312, continues to provide enhanced sealing properties as a result of its lower durometer and positioning about the base material 314.

As will be further discussed below in detail, the anchor member 316 comprising the base material 314 is designed to be cast or locked into one of the two piping members that form the fluid-tight connection 833. The geometrical design of the anchor 316 and sealing member 310 and their interconnection are advantageously constructed to provide optimal sealing capabilities with enhanced strength characteristics. The anchor member 316 comprises substantially resilient shelving portions 328 and 330 that restrain the anchor member 316 within a wall 902 of a pipe member 930 (see FIGS. 15-18). The connecting element 334 is advantageously symmetrically located in the anchor member 316 extending to the sealing member 310 and is of sufficient width defined by sides 332 to prevent fracture or fatigue during assembly or compressive and tensile stresses experienced in use. The arcuate region 336 of the distal end 318 of the anchor member 316 maximizes the surface area along the radial axis of the annular gasket of the interconnection between the sealing member 310 and anchor such that the risk fatigue and/or facture is lessoned.

In addition to the advantages discussed relating to the base material 314 of cords 614 positioned within, the sealing member 310, the geometrical construction of the sealing member and anchor member 316 provide enhanced sealing properties. For example the reduced width at distal end 318 of the anchor 316, expanding by way of the diverging sides 340 and 342 of the sealing member 310 provide superior flexibility to the gasket as the pipe members are being assembled. In addition, the diverging sides 340 and 342 expansion to horizontal peaks 348 is the widest portion of the gasket, maximizing the amount of material used to form the seal in the fluid-tight connection 833. The converging sides 350 and 352 to the arcuate tip 354 reduces material costs by the reduced size while providing a sufficient slope to reassure a fluid-tight connection.

Illustrated in FIG. 14 is a cross-sectional view of annular composite high strength gasket 700 constructed in accordance with another exemplary embodiment of the present disclosure. The composite high strength gasket 700 illustrated in FIG. 14 includes a sealing member 310 comprising sealing material 312 having a first durometer of relatively soft material and a base material 314 located within an anchor member 316 having a second durometer of a relatively harder and higher durometer material than the sealing material.

Integrally formed by for example extruding, co-extruding, or molding into the sealing member 310 is the anchor member 316. The anchor member 316 is also formed from the base material 314. The anchor member 316 comprises a distal end 318 and a proximal end 320. The proximal end 320 comprises a seat 322 having first and second risers, 324 and 326, respectively transversely extending therefrom. The risers 324, 326 terminate at respective shelving portions 328, 330 that transversely extend therefrom to a connecting element 334 that joins the proximal end 320 of the anchor to the distal end 318. The connecting element 334 centrally extends from risers 324, 326 and symmetrically from the proximal end 320 by sides 332 to an arcuate region 336 to an apex 338 of the distal end 318.

At least a portion of the distal end 318 is integrally formed with the sealing member 310, and in the illustrated example embodiment of FIG. 14, the arcuate region 336 is submerged within the sealing member. In the illustrated embodiment, the overall height “h” of the gasket 700 comprises an anchor height “a” that is substantially equal in proportion to sealing height “s” to form the overall height. The overall height “h” can be from one inch (1″) to several inches.

The sealing member 310 comprises a generally diamond shaped head 341, having two diverging sides 342 and 344 that diverge from the anchor member 316 at a base 346 to horizontal peaks 348. From the horizontal peaks 348, the sealing member comprises two converging sides 350 and 352 that join at an arcuate tip 354 of the sealing member 310.

The base material 314 located in the anchor provides relatively significant elongation strength, axial strength (compressive and tensile), and shear strength (both positive and negative) properties, along with relatively high impact properties when compared to the sealing material 312.

The sealing material 312 provides relatively significant sealing properties when compared to the base material 314, such that the sealing material readily conforms to the geometry formed by the piping connection formed between pipe members. The base material 314 is also capable of deforming, although to a relatively lesser degree than the sealing material to facilitate forming the fluid-tight seal connection between piping members.

As will be further discussed below in detail, the anchor member 316 comprising the base material 314 is designed to be cast or locked into one of the two piping members that form the fluid-tight connection 833. The geometrical design of the anchor 316 and sealing member 310 and their interconnection are advantageously constructed to provide optimal sealing capabilities with enhanced strength characteristics. The anchor member 316 comprises substantially resilient shelving portions 328 and 330 that restrain the anchor member 316 within a wall 902 of a pipe member 930 (see FIGS. 15-18). The connecting element 334 is advantageously symmetrically located in the anchor member 316 extending to the sealing member 310 and is of sufficient width defined by sides 332 to prevent fracture or fatigue during assembly or compressive and tensile stresses experienced in use. The arcuate region 336 of the distal end 318 of the anchor member 316 maximizes the surface area along the radial axis of the annular gasket of the interconnection between the sealing member 310 and anchor such that the risk fatigue and/or facture is lessoned.

In addition to the advantages discussed relating to the base material 314 connected with the sealing member 310, the geometrical construction of the sealing member and anchor member 316 provide enhanced sealing properties. For example the reduced width at distal end 318 of the anchor 316, expanding by way of the diverging sides 340 and 342 of sealing member 310 provide superior flexibility to the gasket as the pipe members are being assembled. In addition, the diverging sides 340 and 342 expansion to horizontal peaks 348 is the widest portion of the gasket, maximizing the amount of material to form the seal in the fluid-tight connection 833. The converging sides 350 and 352 to the arcuate tip 354 reduces material costs by the reduced size while providing a sufficient slope to reassure a fluid-tight connection.

Illustrated in FIGS. 15-18 are cross sectional partial views of the annular composite high strength gasket 300, 400, 500, 600, and 700, constructed in accordance with one example embodiment of the present disclosure cast in one of an adjoining pipe member 930 and mating pipe member 932 to form a sealing connection 833 (see FIGS. 16 and 18) therebetween. While FIGS. 15-18 illustrate the composite high strength gasket 300 and 600, it would be appreciated by one skilled in the art any of the high strength gaskets discussed in the exemplary embodiments of this disclosure, for example, gaskets 300, 400, 500, 600, and 700 could be used to achieve the sealing connection 833.

In the illustrated example embodiment of FIGS. 15-18, the adjoining member 930 is formed of concrete and cast with any of the high strength gaskets of FIGS. 10-14 of the present disclosure. In FIGS. 15 and 17, the gasket is shown prior to the interconnecting of adjoining pipe member 930 and mating pipe member 932. The annular composite high strength gasket of FIGS. 10-14 shown in FIGS. 15-18 is stretched around the mold of the diameter of the adjoining pipe member 930 (a partial sectional view shown) and formed into the adjoining pipe member during the casting process. Once the adjoining pipe member 930 hardens with the high strength gasket, a fluid-tight connection 833 is formed by advancing the mating pipe member 932 (a partial sectional view shown) over the top of the composite high strength gasket, compressing the gasket with an inner portion 938 against an outer portion 940 of the adjoining pipe member to form a fluid-tight connection 833 shown in FIGS. 16 and 18.

In yet an alternative exemplary embodiment, the adjoining pipe member 930 and mating pipe member 932 are cast iron and any of the high strength gaskets of FIGS. 10-14 are cast into one of the two pipe members 930 or 932 to facilitate the formation of a fluid-tight connection 833 of FIGS. 16 and 18. In yet another alternative exemplary embodiment, the high strength gasket of FIGS. 10-14 is located in an annular slot of one of the two pipe members 930, 932. The annular slot located in the pipe member comprises a profile that matches that of the anchor member 316 such that the pipe members form the fluid-tight connection 833 as illustrated in FIGS. 16 and 18. It should be appreciated by one skilled in the art that the high strength gasket of FIGS. 10-14 could equally be located in the mating pipe member 932 without departing from the spirit and scope of the present disclosure.

Another enhanced strength design feature is illustrated in FIGS. 16 and 18 of the high strength gasket (300, 400, 500, and 600) shown in FIGS. 10-13A and 13B of the present disclosure. In particular, the gaskets of FIGS. 10-13A and 13B when shaped to form the fluid-tight sealing connection 833 of FIGS. 16 and 18, generate a substantially aligned pattern of two or more cords, forming a barrel stack 835 along compression axis “C” and/or position at least one cord 14 within the shear axis “S”. This configuration along the shear “S” and compression “C” axes significantly increase the strength of the seal 833. In the illustrated example embodiment of FIG. 18, the barrel stack 835 is best seen along the “C” axis within the sealing member 310.

For each of the example embodiments discussed above, including for example those exemplary embodiments shown in FIGS. 1-18, the annular composite high strength gasket (10, 100, 200, 300, 400, 500, 600, 700) can be molded, extruded, or co-extruded with both the base material (14, 114, 214, 314) and the sealing material (12, 112, 212, 312) to form a single bonded linear high strength gasket. The single bonded linear gasket (10, 100, 200, 300, 400, 500, 600, 700) that has first and second ends, 16, 18, respectively (see for example FIG. 3) that are welded together to form a continuous annular composite high strength gasket to a specified diameter as a function of the application. For example, the annular diameter of the composite high strength gasket could be as small as a few inches in diameter for residential pipes and extend to over 120″ inches in diameter for concrete pipes used for municipal piping applications. Further discussion of the process of welding ends of linear elastomeric gaskets to form annular gaskets is found in U.S. Pat. No. 7,503,992 that issued on Mar. 17, 2009 and its currently pending U.S. divisional application Ser. No. 12/364,805 filed on Feb. 3, 2009, both of which are assigned to SPRINGSEAL® (Streetsboro, Ohio) and entitled FLASHLESS WELDING METHOD AND APPARATUS, which are incorporated herein by reference in their entirety for all purposes. Because the base material 14 of the cords and seal material 12 are both related thermoplastic materials, they collectively achieve an enhanced strength because of the bonding capability during the molding or extrusion forming process.

Some gasket applications impose minimum tensile strength before the gaskets can be used. For example, rubber gaskets used with circular concrete culverts and sewer pipes may be required to satisfy ASTM C-443 that requires a minimum tensile strength of 1200 psi. In order to achieve the minimum tensile strength requirement, conventional circular concrete gaskets are made from a single durometer material such as: polyisoprene; nitrile, ethylene propylene (“EPDM”); and neoprene. However, in order to satisfy the tensile strength requirements, the sealing characteristics of the above conventional circular concrete gaskets are compromised. The composite high strength structure of the composite high strength gasket (10, 100, 200, 300, 400, 500, 600, 700) of the present disclosure shown in FIGS. 1-18 overcomes such deficiencies by providing the required tensile strength through the base material (14, 114, 214, 314) forming cords in the example embodiments of FIGS. 1-13 and 15-18 that provide greater compression resistance during assembly between adjoining pipe members while providing at the same time the gasket with enhanced sealing characteristics achieved by the softer more pliable sealing material (12, 112, 212, 312) having a relatively lower durometer.

In the illustrated embodiments of FIGS. 1-13 and 15-18, the base material (14, 114, 214, 314) comprising a cord or plurality of cords shown in the embodiments of FIGS. 1-13 and 15-18 have a circular cross-section of a 0.100″ inch diameter each, but could have a diameter ranging from 0.030″ to 0.5″ or equivalent surface area for other geometrical cross-sections that also could be used without departing from the spirit and scope of the claimed invention. In the illustrated embodiment of FIGS. 1-5, the sealing material 12 provides a circular or round profile 20, but could be any geometrical configuration also without departing from the spirit and scope of the claimed invention.

In the illustrated embodiment of FIGS. 2-5 and 11-13 in which the cord or cords (14X, 14A-14N, 114A-114N, 214A-214N, 313, 314A-314N, 414A-414N, 515A-515N, and 614A-614N) are approximately 0.100″ inches in diameter with a range of 0.030″ to 0.25″ inches in diameter, the sealing diameter represented by reference character “D” is approximately 1″ inch, but could range between 0.25″ to 3.00″ with the cord diameter increasing or decreasing accordingly. It should be appreciated however, that proportionally larger and smaller cord dimensions would be required for a larger and a smaller diameter outer diameter D and are intended to be covered by the spirit and scope of the claimed invention. In yet another exemplary embodiment, the cord or cords of FIGS. 1-13 and 15-18 have a collective cross-sectional area ranging between twenty-five (25) and sixty (60) percent of the total surface area of the composite high strength gasket, and is preferably between forty (40) and fifty (50) percent of the total surface area.

In the illustrated embodiments of FIGS. 1-18, the lower durometer sealing material (12, 112, 212, 312) is pliable elastomeric material highly conducive for sealing and has a durometer between 40 and 60 on a Shore A scale. An example of such material includes ASTM F477 Low Head material (ASTM F477 LH) which has a durometer of 50 plus or minus five. One company that makes ASTM F477 LH material is Advanced Elastomer Systems L.P. located in Akron, Ohio under their brand name SANTOPRENE®. Advanced Elastomer Systems' part number for SANTOPRENE® is 101-55. Multibase, a Dow Corning Company also produces ASTM F477 LH material under the part number 5904LC. Another suitable material includes SARLINK® 4155 a thermoplastic elastomeric material manufactured by DSM Thermoplastic Elastomers, Inc. located in St. Leominster, Mass. Although elastomeric materials have been discussed, various polymers, natural rubbers, or combinations thereof having a durometer between 40 and 60 on a Shore A scale could also be used as a suitable sealing material without departing from the spirit and scope of the claimed invention.

In the illustrated embodiments of FIGS. 1-18, the higher durometer base material (14, 114, 214, 314) is a thermoplastic elastomeric material having a having a durometer ranging between 60-70 on a Shore A scale through 40-50 on a Shore D scale. It is noted that any material having such relative hardness and flexibility can be used, and examples of suitable materials include High Density Polyethylene (“HDPE”) plastic, thermoplastic vulcanizates (“TPV”), thermoplastic polyoefin (“TPO”), and polypropylene plastic. Although elastomeric materials have been discussed, various polymers, natural rubbers, or combinations thereof having a durometer between 60-70 on a Shore A scale through 40-50 on a Shore D scale could also be used as a suitable inner material without departing from the spirit and scope of the claimed invention.

The following test results are provided, showing the increased amount of strength realized in a high strength gasket 10 reassembling the configuration illustrated in the exemplary embodiment of FIG. 20. The tested gasket comprises the following dimensions:

D1 (outer overall diameter OD)=0.875″

Cord (14X) having an outer diameter D2=0.375″

The tensile strength of the composite gasket 10 having the above dimensions and as shown in FIG. 20 was 2,600 psi. In a similar test, the sealing material (12) of the same overall diameter D1, but without the base material (14) had a tensile strength of only 750 psi.

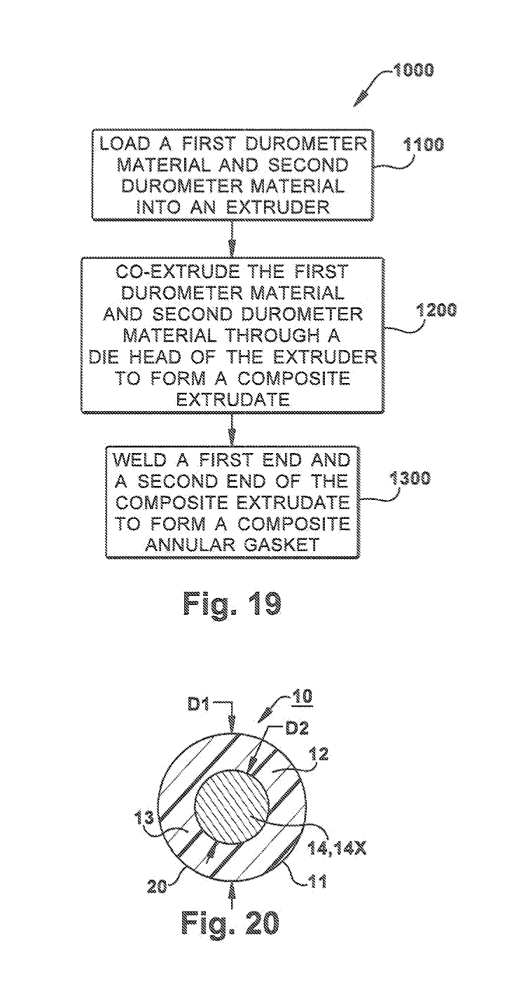

FIG. 19 is a flowchart of exemplary embodiment of the present disclosure illustrating a method 1000 of forming a composite high strength annular gasket of FIGS. 1-18 in accordance with one embodiment of the present disclosure. At 1100, a first durometer material and a second durometer material are loaded into an extruder. At 1200, the first and second material are co-extruded through a die-head of the extruder to form a composite extrudate. At 1300, a weld is formed between a first end and a second end of the composite extrudate to form a composite high strength annular gasket of desired length. Further discussion relating to a co-extrusion process is found in the '905 patent.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A composite high strength annular gasket for forming a seal between two pipe members comprising:
a sealing material having a first durometer, said sealing material providing a pliable flexing surface for forming a sealing connection between a mating pipe member and adjoining pipe member during assembly; and
a base material forming one or more cords having a second durometer, said one or more cords embedded in and bonded with said sealing material providing enhanced anti-compression and tensile strength to said composite annular gasket, the base material having a durometer higher than said sealing material.

2. The composite high strength annular gasket of claim 1 wherein the total surface area of said one or more cords is approximately 50 percent of the total surface area of said annular gasket.

3. The composite high strength annular gasket of claim 1 wherein said base material comprising one or more cords is a single cord substantially centrally located in said sealing material.

4. The composite high strength annular gasket of claim 3 wherein the total surface area of said cord is approximately 50 percent of the total surface area of said annular gasket.

5. The composite high strength annular gasket of claim 1 wherein said base material of one or more cords comprises a plurality of cords forming an x configuration.

6. The composite high strength annular gasket of claim 5 wherein the total surface area of said plurality of cords is approximately 50 percent of the total surface area of said annular gasket.

7. The composite high strength annular gasket of claim 1 wherein said one or more cords comprises a plurality of cords formed from said base material being substantially symmetrically located within said sealing material.

8. The composite high strength annular gasket of claim 1 wherein said geometrical construct of said sealing material and cords are substantially circular.

9. The composite high strength annular gasket of claim 1 wherein said one or more cords is positioned for movement within a shear axis forming a fluid tight connection between pipe members during assembly.

10. The composite high strength annular gasket of claim 1 wherein said one or more cords comprises a plurality of cords moveably located within said gasket to form a barrel stack along a compression axis during assembly of pipe members.

11. A method of forming a composite high strength annular gasket comprising:
loading first and second durometer materials into an extruder to form a composite extrudate, the first durometer material forming a sealing member of the composite extrudate that also provides support to the second durometer material, said second durometer material forming one or more cords during the co-extrusion process, the one or more cords providing anti-compression and tensile strength to said composite high strength annular gasket during assembly of connecting pipe members;
co-extruding the first durometer material with said second durometer material through a die head of an extruder to form a composite extrudate, the first durometer material having a lower durometer value than said second durometer material; and
welding first and second ends of the composite extrudate to form a continuous composite high strength annular gasket.

12. The method of claim 11 further comprising isolating a plurality of cords formed from the second durometer material extruded through the die head by the first durometer material such that each second durometer cord is not in contact with any other of said plurality of cords, each cord being separated and supported by said first durometer material.

13. A composite high strength annular gasket for forming a seal between two pipe members comprising:
a sealing member formed from sealing material having a first durometer, said sealing material providing a pliable flexing surface for forming a sealing connection between a mating pipe member and adjoining pipe member during assembly;
an base material formed from a second durometer, said base material providing enhanced anti-compression and tensile strength to said composite high strength annular gasket, the base material having a durometer higher than said sealing material;
a plurality of cords formed from said base material, the plurality of cords being embedded in and supported by said sealing material; and
an anchor member integrally formed with sealing member, the anchor member being formed from said base material.

14. The composite high strength composite gasket of claim 13 wherein said anchor member further comprises a connecting element of reduced size providing coactable flexing of the anchor member and sealing member during assembly between two pipe members.

15. The composite high strength composite gasket of claim 14 wherein said sealing member comprises first and second ends diverging away from said ends to a midpoint of said sealing member such that the widest portion of said sealing member along a radial axis is at said midpoint.

16. The composite high strength annular gasket of claim 13 wherein the total surface area of said plurality of cords is approximately 50 percent of the total surface area of said sealing member.

17. The composite high strength annular gasket of claim 13 wherein said plurality of cords formed from said base material are substantially symmetrically located within said sealing material of said sealing member.

18. The composite high strength annular gasket of claim 13 wherein said plurality of cords are positioned for movement within a shear axis forming a fluid tight connection between pipe members during assembly.

19. The composite high strength annular gasket of claim 13 wherein said plurality of cords are moveably located within said sealing member to form a barrel stack along a compression axis during assembly of pipe members.

20. The composite high strength annular gasket of claim 13 wherein said plurality of cords and anchor member collectively formed from said base material are simultaneously co-extruded with said sealing material forming said sealing member.
